(19) United States
(12) Patent Application Publication
(10) Pub. No.: US 2026/0296409 A1
(43) Pub. Date: Oct. 1, 2026

(54) CONTROL APPARATUS

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Kazuhisa HASHIMOTO, Tokyo (JP); Takuya KAMINADE, Okazaki-shi (JP); Masashi OISHI, Owariasahi-shi (JP)

(21) Appl. No.: 19/577,864

(22) Filed: Mar. 25, 2026

(30) Foreign Application Priority Data
Mar. 27, 2025 (JP) 2025-053550

(51) Int. Cl. B60W 30/06

(52) U.S. Cl. CPC B60W 30/06; B60W 2420/403

(57) ABSTRACT

A control apparatus includes an environmental information obtainer which acquires information about an environment around an ego vehicle, a parking lot likelihood calculator which derives, by using the environmental information, a parking lot likelihood representing a likelihood that a parking lot candidate corresponds to a parking lot, a space likelihood calculator which derives, by using the environmental information, a parking space likelihood regarding a parking space in the parking lot, and a parking lot determiner which analyzes the parking lot likelihood and the parking space likelihood to determine whether the ego vehicle may come into contact with, that is, enter the parking lot. This improves the accuracy of determining whether the ego vehicle may come into contact with the parking lot.

The present application claims the benefit of priority of Japanese Patent Application No. 2025-053550 filed on Mar. 27, 2025, the disclosure of which is incorporated in its entirety herein by reference.

### TECHNICAL FIELD

This disclosure relates generally to a control apparatus.

### BACKGROUND ART

Japanese Patent First Publication No. 2023-154553 discloses a control device configured to determine whether the ego vehicle is present in a parking lot, the control device being configured to acquire a parking row by detecting a parking space and/or a parked vehicle using image data obtained by capturing an area around the ego vehicle, and determining whether the ego vehicle is present in the parking lot having the parking row.

### SUMMARY

For example, in a scene in which a lane and a vehicle arrangement pattern on a public road are confusingly similar to a parking space and a parked vehicle arrangement pattern in a parking lot, accuracy in detecting the parking space, the parked vehicle, and the parking row may decrease, thereby possibly decreasing accuracy of determination as to whether the ego vehicle is present in the parking lot and accuracy of determination as to whether contact between the parking lot and the ego vehicle is predicted. Therefore, a technique for improving accuracy of such determinations is desired. It is noted that the term “contact” as used in this disclosure, as also described later in detail, refers to a situation in which the ego vehicle enters a space in a parking lot, or the predicted travel trajectory of the ego vehicle intersects a space in the parking lot, unless otherwise specified.

The present disclosure is implemented in the following forms.

According to one aspect of this disclosure, there is provided a control apparatus which comprises: (a) an environmental information obtainer that is configured to obtain environmental information representing an environment around an ego vehicle using one or more sensors including at least a camera; (b) a parking lot likelihood calculator that is configured to use the environmental information to determine a parking lot likelihood indicating a likelihood that a parking lot candidate corresponds to a parking lot; (c) a parking space likelihood calculator that is configured to use the environmental information to determine a parking space likelihood relating to a parking space in the parking lot; and (d) a parking lot determiner that is configured to execute a determination process of determining, based on the parking lot likelihood and the parking space likelihood, whether the ego vehicle is likely to come into contact with the parking lot.

The above arrangements of the control apparatus is capable of determining, with higher accuracy, whether the ego vehicle may come into contact with the parking lot by taking into consideration the parking lot likelihood indicating a likelihood that the parking lot candidate corresponds to the parking lot and the parking space likelihood regarding parking spaces in the parking lot candidate.

### BRIEF DESCRIPTION OF THE DRAWINGS

The present disclosure will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is an explanatory diagram illustrating a schematic configuration of a control device according to a first embodiment;

FIG. 2 is an explanatory diagram illustrating an example of a situation in which an ego vehicle is likely to come into contact with a parking lot;

FIG. 3 is a flowchart of a parking-lot searching program according to the first embodiment;

FIG. 4 is a flowchart of the space likelihood determination task according to the first embodiment;

FIG. 5 is a flowchart of a parking lot searching program according to a second embodiment; and

FIG. 6 is an explanatory diagram illustrating an example of a parking lot that satisfies a crosswalk pattern condition.

### DESCRIPTION OF THE PREFERRED EMBODIMENTS

### FIRST EMBODIMENT

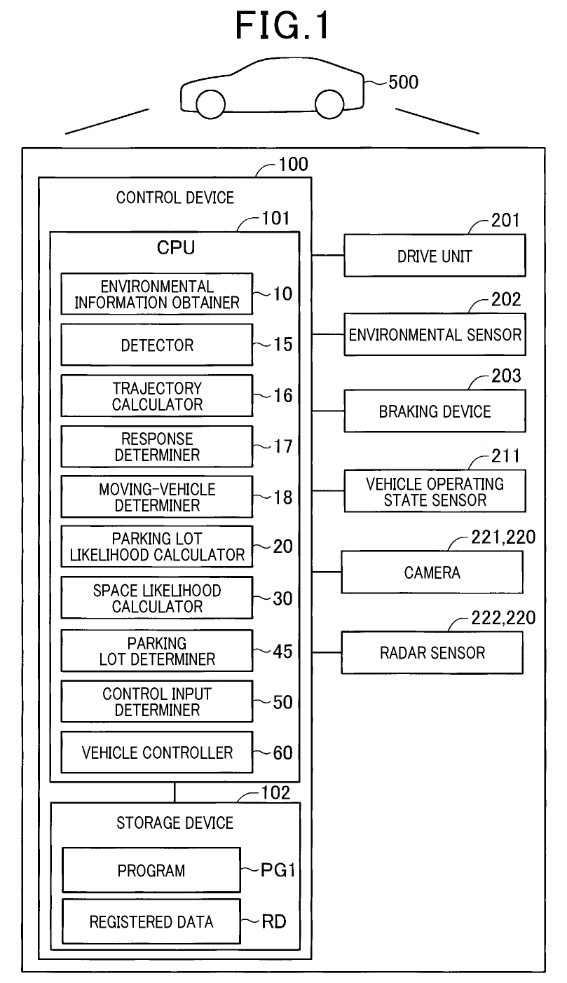

The control device 100 illustrated in FIG. 1 is mounted on the vehicle 500. The control device 100 is communicably connected to the drive unit 201, the steering device 202, the braking device 203, the vehicle operating state sensor 211, the camera 221, and the radar sensor 222, which are mounted on the vehicle 500. The vehicle 500 may be any one of a hybrid electric vehicle (HEV), a plug-in hybrid electric vehicle (PHEV), a fuel cell electric vehicle (FCEV), a battery electric vehicle (BEV), and an engine vehicle. Hereinafter, the vehicle 500 on which the control device 100 is mounted is also referred to as an ego vehicle.

The drive unit 201 generates a driving force or torque to be transmitted to drive wheels of the vehicle 500. The drive unit 201 may be an electric motor or an internal combustion engine. The steering device 202 works to steer wheels of the vehicle 500. The steering device 202 is, for example, an electric power steering device. The braking device 203 applies a braking force to the wheels of the vehicle 500. The braking device 203 is, for example, a disc brake device.

The vehicle operating state sensor 211 derives information about an operating state of the vehicle 500. The vehicle operating state sensor 211 includes, for example, a vehicle speed sensor, an accelerator pedal sensor, a brake pedal sensor, a steering angle sensor, and a turn signal switch. The vehicle operating state sensor 211 works to detect or measure, for example, a travel speed of the vehicle 500, an accelerator pedal position, a brake pedal position, a steering angle of a steering wheel, and a turn signal operation state of the vehicle 500, and transmits the measured parameters to the control device 100 as representing the operating state of the vehicle 500.

The camera 221 works to capture an image of the surroundings of the vehicle 500. The image may be a still image or a moving image. The camera 221 captures at least an image of an area in front of the vehicle 500. The vehicle 500 may include a plurality of cameras 221 configured to capture images of areas in front of, to the left and right of, and behind the vehicle 500. The camera 221 transmits image data to the control device 100.

The radar sensor 222 detects objects around the vehicle 500. Specifically, the radar sensor 222 emits an electromagnetic wave toward the surroundings of the vehicle 500 and receives a reflected wave from the object, thereby measuring a distance to the object, an angle to the object, and a relative velocity of the object. The radar sensor 222 may be implemented by a millimeter-wave radar, LiDAR (Light Detection and Ranging). The radar sensor 222 transmits detected information, such as the distance and the angle, to the control device 100.

The control device 100 includes the CPU 101 and the storage device 102 and is implemented as an ECU (Electronic Control Unit). The storage device 102 includes, for example, a ROM, a RAM, and a hard disk drive, and stores a program PG1 and the registered data RD. The CPU 101 executes the program PG1 stored in the storage device 102 to cause the control device 100 to function as the environmental information obtainer 10, the detector 15, the trajectory calculator 16, the correspondence determiner 17, the moving-vehicle determiner 18, the parking lot likelihood calculator 20, the space likelihood calculator 30, the parking lot determiner 45, the control input determiner 50, and the vehicle controller 60.

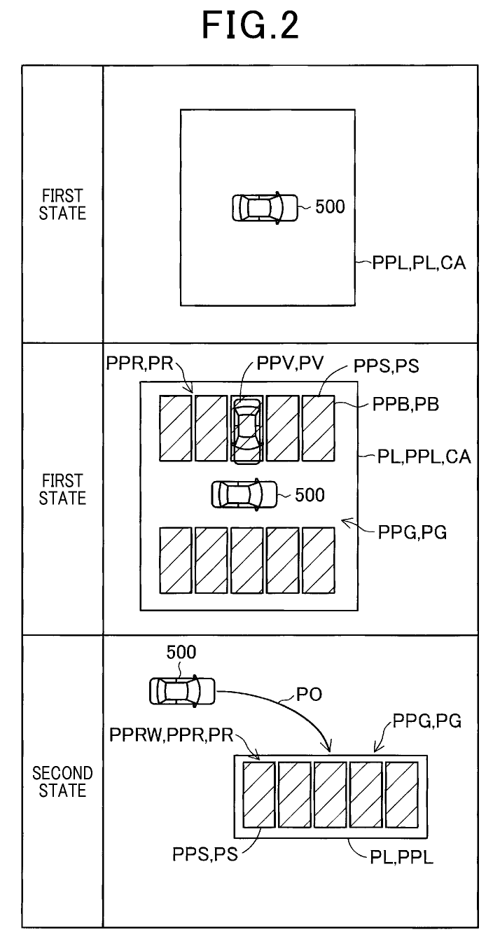

The control device 100 functions, as illustrated in FIG. 2, as a determination device configured to determine whether there is a possibility that the ego vehicle 500 will contact the parking lot PL. In the present disclosure, the phrase “there is a possibility that the ego vehicle 500 will contact the parking lot PL” refers to at least one of: (i) a first state in which the ego vehicle 500 is located within a space of the parking lot PL; and (ii) a second state in which the ego vehicle 500 is expected or predicted to enter the space of the parking lot PL. Specifically, the second state means that the predicted trajectory PO contacts, that is, intersects with, the space of the parking lot PL.

The environmental information obtainer 10 illustrated in FIG. 1 acquires environmental information using one or more environmental sensors 220. The environmental sensors 220 include at least the camera 221 and, in the present embodiment, further include the radar sensor 222. The environmental information obtainer 10 works to acquire, as the environmental information, an image of surroundings captured by the camera 221 (which will also be referred to below as a surrounding environment image) and received data generated by the radar sensor 222. The surrounding environment image shows the surroundings of the ego vehicle 500. The received data is derived using a wave which has been reflected from an object and received by the radar sensor 222.

The detector 15 detects, as illustrated in FIG. 2, a parking lot candidate PPL in the surrounding environment image. The parking lot candidate PPL is a candidate for the parking lot PL and is a location that may correspond to the parking lot PL. The parking lot candidate PPL may or may not be the parking lot PL. FIG. 2 illustrates examples in which the parking lot candidate PPL corresponds to the parking lot PL.

The detector 15 detects the parking lot candidate PPL in the surrounding environment image using, for example, a first detection model that is pre-trained to detect the parking lot candidate PPL using the surrounding environment image. The first detection model may be, for example, a machine learning model using a convolutional neural network. Alternatively, the detector 15 may detect the parking lot candidate PPL using a technique such as pattern matching or edge detection. Further, in detecting the parking lot candidate PPL, the detector 15 may consider presence or absence of a parking space candidates PPS and a parking row candidate PPR, which will be described later.

The detector 15 also works to detect the parking space candidates PPS included in the surrounding environment image captured by the camera 221. The parking space candidates PPS are candidates for the parking spaces PS, in other words, spaces that may be the parking spaces PS. Each of the parking spaces PS is a space in which one vehicle 500 is permitted to be parked. Each of the parking space candidates PPS are determined using the parking frame candidates PPB and/or the parked vehicle candidate PPV. The parking frame candidates PPB are candidates for the parking frames PB, in other words, spaces that may be the parking frames PB. The parked vehicle candidate PPV is a candidate for a parked vehicle PV, in other words, an object that may be the parked vehicle PV. Note that FIG. 2 illustrates examples in which the parking space candidates PPS are actually the parking spaces PS. In FIG. 2, hatching is applied to the parking space candidates PPS and the parking spaces PS.

The detector 15 works to determine the parking frame candidates PPB included in the surrounding environment image, for example, using the second detection model that has been trained in advance to detect the parking frame candidates PPB using an input of the surrounding environment image. The second detection model is, for example, implemented by a machine learning model similar to the first detection model. Note that the detector 15 may detect the parking frame candidates PPB included in the surrounding environment image using a technique such as pattern matching or edge detection. Each of the parking frame candidates PPB is determined, for example, as representing one of the following regions (a) to (e). However, the parking frame candidates PPB are not limited to the regions (a) to (e), and may be detected as regions having other shapes.
(a) A region between two parallel lines drawn on a road surface.
(b) A region between two elongated U-shaped lines drawn on a road surface.
(c) A region defined by a rectangular line drawn on a road surface and lacking one short side.
(d) A region inside a rectangle drawn on a road surface.
(e) A region between two parallel double lines drawn on a road surface.

The detector 15 detects the parked vehicle candidate PPV included in the surrounding environment image (i.e., an image of the surroundings of the vehicle 500), for example, using a third detection model that has been trained in advance to detect the parked vehicle candidate PPV with the surrounding environment image as an input. The third detection model may be implemented by a machine learning model similar to the first detection model. The detector 15 may alternatively be configured to detect the parked vehicle candidate PPV included in the surrounding environment image using a technique such as pattern matching or edge detection.

The detector 15 also detects the parking row candidate PPR included in the surrounding environment image. The parking row candidate PPR is a candidate for the parking row PR, which is a row of the parking spaces PS, in other words, a space that may be the parking row PR. The detector 15 detects the parking row candidate PPR by using detection results of the parking space candidates PPS. The detector 15 may detect the parking row candidate PPR by using environmental information instead of the detection results of the parking space candidates PPS, or in addition thereto. Note that FIG. 2 illustrates examples in which the parking row candidate PPR is actually the parking row PR.

The parking row PR includes at least a predetermined number of the parking spaces PS that are continuous in a left-right direction. The left-right direction herein refers to a left-right direction of the parking spaces PS. In the present embodiment, the left-right direction of the parking spaces PS means the lateral direction, which is oriented parallel to a short-side of a set of the parking spaces PS. Further, a front-rear direction of the parking spaces PS means a longitudinal direction, which is oriented parallel to a long-side of the set of the parking spaces PS. The predetermined number is defined as a number of two or more. Further, the phrase “the parking spaces PS are continuous in the left-right direction” means that a distance between a respective adjacent two of the parking spaces PS in the left-right direction is not greater than a predetermined left-right distance. Similarly, the parking row candidate PPR includes at least a predetermined number of the parking spaces PS that are continuous in the left-right direction.

The detector 15 also determines the parking row group candidate PPG. The parking row group candidate PPG is a candidate for the parking row group PG, in other words, a space that may be the parking row group PG. The parking row group PG includes one or more of the parking rows PR that satisfy a predetermined parking row pattern. The parking row pattern represents an arrangement pattern of the parking rows PR. The parking row pattern is, for example, an I-shaped pattern in which the parking row PR extends in one direction, an II-shaped pattern in which two parking rows PR are arranged in parallel with a space therebetween, a cross-shaped pattern in which a plurality of parking rows PR are arranged such that a cross-shaped traveling path is defined between the plurality of the parking rows PR, a T-shaped pattern in which a plurality of parking rows PR are arranged such that a T-shaped traveling path is defined between the plurality of the parking rows PR, and an L-shaped pattern in which two or more parking rows PR are arranged in an L-shape. Further, the parking row group candidate PPG includes one or more of the parking row candidates PPR that satisfy the parking row pattern. Note that the middle portion of FIG. 2 illustrates the parking row group candidate PPG of the II-shaped pattern, and the lower portion of FIG. 2 illustrates the parking row group candidate PPG of the I-shaped pattern. The detector 15 determines the parking row group candidate PPG using a detection result of the parking row candidate PPR. Note that FIG. 2 illustrates examples in which the parking row group candidate PPG is actually the parking row group PG.

The trajectory calculator 16 derives the predicted trajectory PO. The predicted trajectory PO is a calculated traveling trajectory of the ego vehicle 500. The trajectory calculator 16 derives the predicted trajectory PO, for example, by calculating the traveling trajectory of the ego vehicle 500 based on a steering angle, a vehicle speed, and an acceleration obtained by the vehicle operating state sensor 211.

The correspondence determiner 17 determines whether the parking lot candidate PPL corresponds to a predetermined space using the environmental information. Specifically, the correspondence determiner 17 determines whether the parking lot candidate PPL corresponds to the registered parking lot that has been registered in advance. The registered parking lot is a parking lot stored in the control device 100 by, for example, an operator or a user of the ego vehicle 500. In the present embodiment, the correspondence determiner 17 determines whether the parking lot candidate PPL is a registered parking lot by collating information based on the environmental information with the registration information RD stored in the storage device 102. The registration information RD includes, for example, information representing the position of the registered parking lot and observation information obtained by observing the registered parking lot or a vicinity of the registered parking lot. The observation information is obtained, for example, by using the environmental sensors 220. The correspondence determiner 17 collates the registration information RD with the position information about the parking lot candidate PPL and the environmental information. The position information about the parking lot candidate PPL may be obtained, for example, by using the environmental information.

The moving-vehicle determiner 18 determines whether a moving vehicle is present using the environmental information. The moving vehicle is the vehicle 500 moving in the parking frame PB.

The parking lot likelihood calculator 20 executes a parking lot likelihood calculating task. The parking lot likelihood calculating task is a process of determining a parking lot likelihood by using the environmental information acquired by the environmental information obtainer 10. The parking lot likelihood represents a likelihood that the parking lot candidate PPL corresponds to the parking lot PL, that is, a likelihood that the parking lot candidate PPL is actually the parking lot PL. The parking lot likelihood is used in a determination process described later. In the present embodiment, the parking lot likelihood of the parking lot candidate PPL with which the ego vehicle 500 is in contact, that is, in which the ego vehicle 500 is located, is used in the determination process. Specifically, the parking lot likelihood is calculated as a likelihood that does not depend on the parking spaces PS. In other words, the parking lot likelihood may be derived regardless of whether the parking space candidates PPS are included in the parking lot candidate PPL.

The parking lot likelihood calculator 20 obtains, for example, various types of information regarding the parking lot candidate PPL by using the environmental information, and calculates the parking lot likelihood using the acquired various types of information. The various types of information regarding the parking lot candidate PPL include, for example, information representing a shape, a position, surrounding indicators, surrounding objects, and the like of the parking lot candidate PPL. A surrounding indicator of a certain place or of a spatial region including a three-dimensional space of the place is an indicator present around the place or the spatial region. A surrounding object of a certain place or a spatial region is an object present around the place or within the spatial region. For example, when a traffic light or a crosswalk pattern is detected around the parking lot candidate PPL, the parking lot likelihood calculator 20 calculates a parking lot likelihood representing a lower likelihood than that in a case where no traffic light or crosswalk pattern is detected around the parking lot candidate PPL. Accordingly, it is possible to suppress an inappropriate increase in the parking lot likelihood of the parking lot candidate PPL that is actually an intersection. The “crosswalk pattern” is a pattern in which a plurality of white lines extending in a first direction and parallel to each other are arranged in a second direction orthogonal to the first direction. Further, when a wall, a curb, a fence, a hedge, or the like is detected around the parking lot candidate PPL, the parking lot likelihood calculator 20 derives a parking lot likelihood representing a higher likelihood than that in a case where no wall, curb, fence, hedge, or the like is detected around the parking lot candidate PPL. This causes the parking lot likelihood of the parking lot candidate PPL to be appropriately increased when a probability that the parking lot candidate PPL is actually the parking lot PL is high.

In the present embodiment, the parking lot likelihood calculator 20 derives a parking lot likelihood that is higher when the parking lot candidate PPL corresponds to a registered parking lot than when the parking lot candidate PPL does not correspond to a registered parking lot, based on a determination result of the correspondence determiner 17. When the parking lot candidate PPL corresponds to a registered parking lot, the parking lot likelihood calculator 20 may derive or determine a particularly high parking lot likelihood such that a first condition described later is reliably satisfied in a determination process described later. When the parking lot candidate PPL corresponds to a registered parking lot, it is highly likely that the parking lot candidate PPL is actually a parking lot PL. This minimizes an inappropriate decrease in the parking lot likelihood of the parking lot candidate PPL that is actually a parking lot PL.

The space likelihood calculator 30 executes a space likelihood determination task. The space likelihood determination task is a process of calculating a parking space likelihood using the environmental information acquired by the environmental information obtainer 10. The parking space likelihood represents a likelihood regarding the parking spaces PS.

The parking space likelihood, as referred to herein, includes a first parking space likelihood and a second parking space likelihood. The first parking space likelihood is a parking space likelihood regarding the parking spaces PS in the contact area CA. More specifically, the first parking space likelihood is a likelihood that the parking space candidates PPS in the contact area CA actually correspond to the parking spaces PS. The contact area CA corresponds to the parking lot candidate PPL in which the ego vehicle 500 is present. When the contact area CA does not exist, the space likelihood calculator 30 obtains, as the first parking space likelihood, the lowest likelihood, for example, a likelihood of zero. The second parking space likelihood represents a parking space likelihood regarding the parking spaces PS that are expected or predicted to come into contact with the ego vehicle 500. More specifically, the second parking space likelihood is a likelihood that the parking row candidate PPRW scheduled for contact with the ego vehicle 500 actually corresponds to the parking row PR. The space likelihood calculator 30 calculates the second parking space likelihood by using the predicted trajectory PO predicted by the trajectory calculator 16. The first parking space likelihood and the second parking space likelihood are used in a determination process described later.

In the present embodiment, each of the first parking space likelihood and the second parking space likelihood represents a parking row likelihood. The parking row likelihood is a likelihood regarding the parking row PR. More specifically, the first parking space likelihood corresponds to a group likelihood of the parking row group candidates PPG included in the contact area CA. The group likelihood represents a likelihood that the detected parking row group candidates PPG correspond to the parking row groups PG. The second parking space likelihood corresponds to a row-by-row likelihood. The row-by-row likelihood represents a likelihood that the parking row candidate PPR corresponds to the parking row PR. More specifically, the second parking space likelihood is a per-row likelihood of the parking row candidate PPRW scheduled or expected for contact with the ego vehicle 500.

In the following discussion, the likelihood that each of the parking space candidates PPS correspond to one of the parking spaces PS is also referred to as a per-space likelihood. The space likelihood calculator 30 calculates the per-row likelihood and a group likelihood using the per-space likelihood.

The space likelihood calculator 30 derives various types of information about the parking space candidates PPS using the environmental information, and determines the parking space likelihood using the derived various types of information. The various types of information about the parking space candidates PPS are, for example, information indicating a shape, a position, a surrounding feature, and a surrounding object of each of the parking space candidates PPS. For example, when the following conditions A, B, and C are satisfied, the space likelihood calculator 30 determines a lower per-space likelihood than in a case where these conditions are not satisfied. This minimizes an inappropriate increase in the parking space likelihoods of the parking space candidates PPS that are actually located in a place different from the parking lot PL, such as a public road.
Condition A: the parking frame PB serving as a corresponding one of the parking space candidates PPS defines an area or space delimited only by two parallel lines.
Condition B: no object adjacent to a corresponding one of the parking space candidates PPS exists in the front-rear direction of the parking space candidate PPS. Condition
C: a traffic signal or a crosswalk pattern exists around a corresponding one of the parking space candidates PPS.

When Condition A is not satisfied, each of the parking frame candidates PPB included in the parking lot candidate PPL is, for example, an area between the above-described two U-shaped lines, an inner area of a rectangle lacking one short side, an inner area of a rectangle drawn on a road surface, an area between two parallel double lines, and the like. The “object” in Condition B is, for example, a wall, a curb, a fence, a hedge, or the like.

As described above, the space likelihood calculator 30 determines each of the per-row likelihoods using the per-space likelihoods. For example, the space likelihood calculator 30 calculates each of the per-row likelihoods based on a statistical value of the per-space likelihoods of the parking space candidates PPS included in a corresponding one of the parking row candidates PPR. More specifically, the space likelihood calculator 30 determines, as the per-row likelihood, an average value or a median value of the per-space likelihoods of the parking space candidates PPS included in a corresponding one of the parking row candidates PPR. In this case, for example, the space likelihood calculator 30 may acquire the statistical value after excluding parking space candidates PPS having per-space likelihoods lower than a predetermined reference value.

The space likelihood calculator 30 also derives the per-space likelihood and the group likelihood. For example, the space likelihood calculator 30 determines the group likelihood based on a statistical value of the per-space likelihoods of the parking space candidates PPS included in a corresponding one of the parking row group candidates PPG. More specifically, for example, the space likelihood calculator 30 determines, as the group likelihood, an average value or a median value of the per-space likelihoods of the parking space candidates PPS included in a corresponding one of the parking row group candidates PPG. In this case, the space likelihood calculator 30 may acquire the statistical value after excluding the parking space candidates PPS having the per-space likelihoods lower than a predetermined reference value. Further, in another embodiment, the space likelihood calculator 30 may acquire the group likelihood using the per-row likelihoods. In this case, for example, the space likelihood calculator 30 may determine, as the group likelihood, an average value or a median value of the per-row likelihoods in substantially the same manner as described above.

The space likelihood calculator 30 may determine various types of information about the parking row PR using the environmental information, and may calculate a corresponding one of the parking space likelihoods using the acquired various types of information. The various types of information about the parking row PR are, for example, information indicating a shape, a position, a surrounding feature, and a surrounding object of the parking row PR. For example, when the following conditions D, E, F, and G are satisfied, the space likelihood calculator 30 determines a lower per-row likelihood and a lower group likelihood than in a case where these conditions are not satisfied.
Condition D: the lateral length of the parking row candidate PPR is shorter than a first length that is a predetermined length, or the lateral length of an area obtained by combining the parking row candidate PPR and the parking row candidate PPR adjacent to the parking row candidate PPR in the lateral direction is shorter than a second length that is a predetermined length.
Condition E: in a longitudinal direction of the parking row candidate PPR, no other parking row candidate PPR exists within a distance shorter than a predetermined distance.
Condition F: the parking row candidate PPR intersects a lane marking line defining a travel lane in which the host vehicle 500 is traveling.
Condition G: in the parking row candidate PPR, a lateral distance between each pair of adjacent parking spaces PS is equal to or greater than a predetermined distance that is a lateral space-to-space interval.

In Condition D, the first length is preferably, for example, 5 m or more. The second length is preferably, for example, 10 m or more. The "predetermined distance" in Condition E is preferably, for example, 2 m or less.

In the present embodiment, the space likelihood calculator 30 uses a determination result of the moving-vehicle determiner 18 to calculate each of the parking space likelihoods which indicates a likelihood lower than that obtained when no moving vehicle exists, when a moving vehicle exists. The parking space likelihood thus obtained may be the per-space likelihood, the per-row likelihood, or the group likelihood. This minimizes an inappropriate increase in the parking space likelihood of a space including the parking frame PB that is actually a public road.

The space likelihood calculator 30 in this embodiment works to analyze the environmental information to determine whether the parked vehicle PV is in a predetermined stopped state. The space likelihood calculator 30 then obtains the parking space likelihood indicating a higher likelihood when the parked vehicle PV is in the predetermined stopped state than when the parked vehicle PV is not in the predetermined stopped state. The parking space likelihood thus obtained may be, for example, the per-space likelihood, the per-row likelihood, or the group likelihood. The predetermined stopped state, as referred to in this embodiment, is a state corresponding to at least one of a drive-off state and a P-range state. The drive-off state is a state in which the drive unit 201 of the parked vehicle PV is in an off-state. The drive-off state includes, for example, a state in which an electric motor is off and a P-range state. The P-range state is a state in which a shift lever of the parked vehicle PV is in a parking position. Accordingly, when the drive unit 201 is in an on-state and the shift lever is in the parking position, the parking space likelihood indicating a higher likelihood is obtained. This appropriately increases the parking space likelihood of the parking frame PB that is highly likely to be the parking frame PB.

More specifically, when determining whether the parked vehicle PV is in the predetermined stopped state, the space likelihood calculator 30 first receives parked-vehicle information including position information and stopped-state information about the parked vehicle PV. The stopped-state information includes at least one of information regarding on/off states of an engine mounted in the parked vehicle PV and information regarding the shift position of the parked vehicle PV. Then, the space likelihood calculator 30 collates the position information about the parked vehicle PV acquired using the environmental information with the position information included in the parked-vehicle information, and determines whether the parked vehicle PV is in the predetermined stopped state using the stopped-state information included in the parked-vehicle information.

The parking lot determiner 45 executes a determination process using the parking-lot likelihood and the parking space likelihood. The determination process is to determine whether there is a possibility that the ego vehicle 500 will contact, that is, enter the parking lot PL.

Specifically, the parking lot determiner 45 determines whether there is a possibility that the ego vehicle 500 will contact with the parking lot PL using the parking-lot likelihood, the first parking space likelihood, and the second parking space likelihood. More specifically, the parking lot determiner 45 determines that there is a possibility that the ego vehicle 500 will contact with the parking lot PL when at least one of a first condition, a second condition, and a third condition is met. The first condition is a condition where the parking-lot likelihood is equal to or greater than a predetermined first threshold. The second condition is a condition where the first parking space likelihood is equal to or greater than a predetermined second threshold. The third condition is a condition where the second parking space likelihood is equal to or greater than a predetermined third threshold is satisfied.

The control input determiner 50 obtains an operation amount of an acceleration operation device installed in the ego vehicle 500. The acceleration operation device is, for example, an accelerator pedal. The operation amount of the acceleration operation device is, for example, an amount by which the accelerator pedal is depressed (which will also be referred to below as a depression amount), i.e., a position of the accelerator pedal. The control input determiner 50 acquires, for example, the depression amount of the accelerator pedal detected by an accelerator sensor included in the vehicle operating state sensor 211.

The vehicle controller 60 executes parking-lot control, which controls travel of the ego vehicle 500 with respect to the parking lot PL, when there is a possibility that the ego vehicle 500 will contact, that is, enter the parking lot PL. Specifically, the parking-lot control includes acceleration suppression control. The acceleration suppression control is a control task for suppressing acceleration of the ego vehicle 500 caused by an operation of the acceleration operation device when an operation amount of the acceleration operation device is equal to or greater than a predetermined threshold. In the parking-lot control, the vehicle controller 60 switches, for example, whether to suppress acceleration of the ego vehicle 500, or varies a degree of suppressing acceleration of the ego vehicle 500, in accordance with the operation amount of the acceleration operation device acquired by the control input determiner 50.

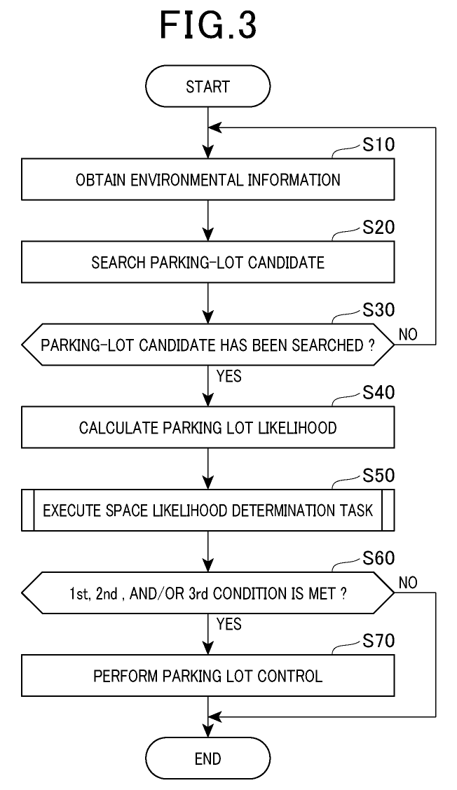

The CPU 101 of the control device 100 executes a parking-lot searching program shown in FIG. 3 at a predetermined cycle when the ego vehicle 500 is traveling at a speed equal to or lower than a predetermined speed or when the ego vehicle 500 is stopped.

After entering the program in FIG. 3, the routine proceeds to step S10 wherein the environmental information obtainer 10 derives the environmental information. The routine proceeds to step S20 wherein the detector 15 searches for the parking-lot candidates PPL included in the peripheral image. The routine proceeds to step S30 wherein the detector 15 determines whether the parking-lot candidates PPL have been determined in step S20. If a YES answer obtained in step S30, meaning that the parking-lot candidates PPL have been detected, then the routine proceeds to step S40. Alternatively, if a NO answer is obtained in step S30, meaning that the parking-lot candidates PPL have not been detected, then the routine returns back to step S10.

In step S40, the parking lot likelihood calculator 20 executes the parking-lot likelihood calculation task. More specifically, in step S40, the parking lot likelihood calculator 20 determines the parking-lot likelihood of the parking-lot candidate PPL detected in step S20 using the environmental information derived in step S10. In step S40, the parking lot likelihood calculator 20 calculates the parking-lot likelihood using various types of information about the parking-lot candidate PPL described above and/or using a determination result of the correspondence determiner 17.

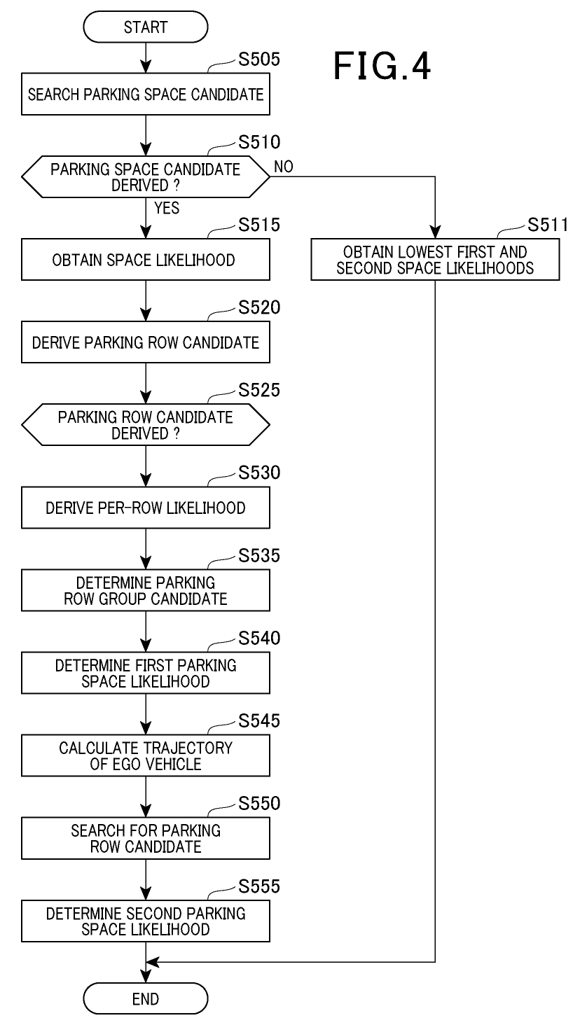

The routine then proceeds to step S50 wherein the space likelihood calculator 30 executes the space likelihood determination task. Specifically, in step S50, the space likelihood determination task shown in FIG. 4 is executed.

In step S505 in FIG. 4, the detector 15 searches for the parking space candidates PPS using the environmental information acquired in step S10 of FIG. 3. Specifically, in step S510, the detector 15 determines whether the parking space candidate PPS has been detected in step S505. If a NO answer is obtained in steps 510, meaning that the parking space candidate PPS has not been detected, then the routine proceeds to step S511 wherein the space likelihood calculator 30 derives a lowest first parking space likelihood and a lowest second parking space likelihood. Alternatively, if a YES answer is obtained in step S510, meaning that the parking space candidates PPS has been detected, then the routine proceeds to step S515 wherein the space likelihood calculator 30 acquires the per-space likelihood of each of the parking space candidates PPS derived in step S505 using the environmental information acquired in step S10 of FIG. 3. Specifically, in step S515, the space likelihood calculator 30 determines the per-space likelihood by using various types of information about a corresponding one of the parking space candidates PPS described above, executing determinations regarding Conditions A to C described above, using a determination result of the moving-vehicle determiner 18, and using a determination result as to whether the parked vehicle PV is in the predetermined stopped state.

The routine proceeds to step S520 wherein the detector 15 derives the parking row candidate PPR using the detection result of the parking space candidates PPS in step S505. The routine proceeds to step S525 wherein the detector 15 determines whether the parking row candidate PPR has been detected in step S520. If a YES answer is obtained in step S525, meaning that the parking row candidate PPR has been detected, then the routine proceeds to step S530 wherein the space likelihood calculator 30 derives the per-row likelihood of the parking row candidate PPR detected in step S520 using the per-space likelihoods obtained in step S515.

The routine proceeds to step S535 wherein the detector 15 searches for the parking row group candidate PPG by using the detection result of the parking row candidates PPR in step S520. The routine proceeds to step S540 wherein the space likelihood calculator 30 acquires the first parking space likelihood by using the detection result of the parking row group candidate PPG in step S535.

The routine proceeds to step S545 wherein the trajectory calculator 16 calculates the predicted trajectory PO of the ego vehicle 500. The routine proceeds to step S550 wherein the detector 15 searches for the parking row candidate PPRW to be entered by the ego vehicle 500 using the predicted trajectory PO derived in step S545 and the parking row candidate PPR detected in step S520 of FIG. 4. The routine proceeds to step S555 wherein the space likelihood calculator 30 uses a detection result of the parking row candidate PPPW derived in step S550 to calculate the second parking space likelihood.

Referring back to step S60 in FIG. 3, the parking lot determiner 45 executes a determination process. More specifically, the parking lot determiner 45 determines whether at least one of the first condition, the second condition, and the third condition is satisfied by using the parking lot likelihood derived in step S40 and the first parking space likelihood and the second parking space likelihood derived in step S50. If a YES answer is obtained in step S60, meaning that at least one of the first condition, the second condition, and the third condition is satisfied, then the routine proceeds to step S70 wherein the vehicle controller 60 executes parking lot control in step S70.

The above-described operation of the control device 100 is capable of determining with higher accuracy whether there is a possibility that the ego vehicle 500 will contact (i.e., enter) the parking lot PL in accordance with the parking lot likelihood indicating that the parking lot candidate PPL corresponds to the parking lot PL and the parking space likelihoods of the parking spaces PS.

In the above-described determination process, the control device 100 analyzes the first parking space likelihood, which is the parking space likelihood of the parking lot candidate PPL with which the ego vehicle 500 is in contact, that is, is located, and the second parking space likelihood, which is the parking space likelihood of the parking space PS with which the ego vehicle 500 is expected to come into contact, to determine whether there is a possibility that the ego vehicle 500 is expected to contact or enter the parking lot PL. Accordingly, by taking into account the parking lot candidate PPL with which the ego vehicle 500 is in contact and the parking space candidate PPS with which the ego vehicle is to come into contact, it is possible to more appropriately determine whether there is a possibility that the ego vehicle 500 will contact the parking lot PL.

When at least one of the first condition, the second condition, and the third condition is satisfied, the control device 100 concludes that there is a possibility that the ego vehicle 500 is expected to contact, that is, enter the parking lot PL. This minimizes an erroneous determination that there is no risk that the ego vehicle 500 may contact the parking lot PL when there is actually a possibility that the ego vehicle 500 will contact, that is, enter the parking lot PL. When at least one of the first condition, the second condition, and the third condition is satisfied, the control device 100 concludes that there is a possibility that the ego vehicle 500 will contact, that is, enter, the parking lot PL. This reduces the likelihood of an erroneous determination that there is no possibility that the ego vehicle 500 will contact, that is, enter, the parking lot PL when such a possibility actually exists.

When a moving vehicle is present, the control device 100 derives the parking space likelihood indicating a lower likelihood. The parking frame candidate PPB in which a moving vehicle is present is less likely to correspond to the parking frame PB in actuality than the parking frame candidate PPB in which no moving vehicle is present. Therefore, when the ego vehicle 500 is located on a public road and there is actually no possibility that the ego vehicle 500 will contact the parking lot PL, the control device 100 is capable of minimizing an erroneous determination that there is a possibility that the ego vehicle 500 will contact the parking lot PL. The reduces a risk that parking lot control may be unnecessarily executed.

In another mode, when a moving vehicle is present, instead of deriving the parking space likelihood indicating a lower likelihood, the vehicle controller 60 may work to exclude the parking frame candidates PPB in which a moving vehicle is present from target locations for which parking lot control is to be executed. In this manner, in the parking lot PL, parking lot control can be appropriately executed in a space having a high probability of corresponding to a parking space PS while suppressing unnecessary execution of parking lot control in a space having a low probability of corresponding to the parking spaces PS. In this embodiment, even when a moving vehicle is present, the parking space likelihood indicating a lower likelihood need not be acquired. That is, for example, the same parking space likelihood may be acquired regardless of whether a moving vehicle is present. In this manner, for example, the parking row likelihood and the group likelihood can be acquired regardless of whether a moving vehicle is present, and it can be determined whether there is a possibility that the ego vehicle 500 will contact, that is, enter the parking lot PL in accordance with the acquired parking row likelihood and group likelihood. Further, when there is a possibility that the ego vehicle 500 will contact, that is, enter the parking lot PL, it is possible to suppress unnecessary execution of parking lot control in a space having a low probability of corresponding to the parking spaces PS.

When the parked vehicle candidate PPV is in a predetermined stopped state, the control device 100 derives the parking space likelihood indicating a higher likelihood. Specifically, when the parked vehicle candidate PPV is in the predetermined stopped state, the parked vehicle candidate PPV is more likely to be an actual parked vehicle PV than the vehicle 500 temporarily stopped on a public road, as compared with a case where the parked vehicle candidate PPV is not in the predetermined stopped state. Therefore, the control device 100 is capable of deriving the parking space likelihood more appropriately in accordance with whether the parked vehicle candidate PPV is in the predetermined stopped state.

Further, when the parking lot candidate PPL corresponds to a registered parking lot, the control device 100 derives the parking lot likelihood indicating a higher likelihood. In this manner, it is possible to determine with higher accuracy whether there is a possibility that the ego vehicle 500 will contact, that is, enter the parking lot PL by using the registered parking lot.

### SECOND EMBODIMENT

The control device 100 according to the second embodiment includes the environmental information obtainer 10 which is capable of obtaining the environmental information from the environmental sensors 220 mounted on a vehicle other than the ego vehicle 500 (which will be referred to below as a second vehicle). The component parts of the control device 100 in the second embodiment are the same as those in the first embodiment unless otherwise specified.

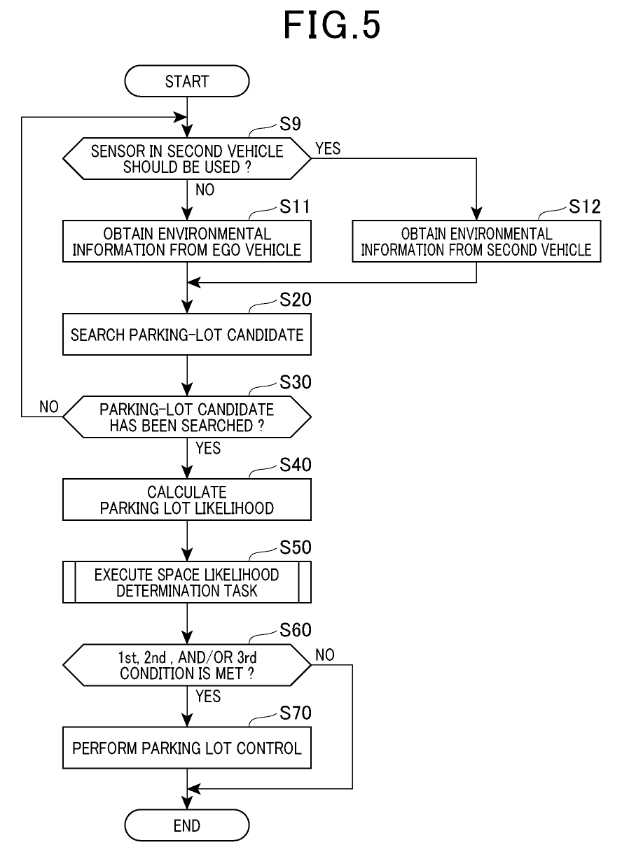

The CPU 101 of the control device 100 executes a parking-lot searching program shown in FIG. 5. First, in step S9, the environmental information obtainer 10 determines whether to use the environmental sensors 220 installed in the second vehicle to obtain the environmental information. Specifically, when the second vehicle is present at a position equal to or less than a predetermined reference distance from the ego vehicle 500, the environmental information obtainer 10 determines to use the environmental sensors 220 of the second vehicle. For example, in a case where the environmental sensors 220 used for acquiring the environmental information representing an environment in front of the ego vehicle are located in front of the ego vehicle 500, it is determined to use the environmental sensors 220 of the second vehicle when the second vehicle is located in front of the ego vehicle 500 and at a position equal to or less than the reference distance from the ego vehicle. Further, for example, the environmental information obtainer 10 may acquire a detection result obtained by the environmental sensors 220 and determine to use the environmental sensors 220 of the second vehicle when a degree of presence of a signal derived from the second vehicle in the acquired detection result is equal to or greater than a reference value. In other words, the environmental information obtainer 10 determines to use the environmental sensors 220 of the second vehicle when acquisition of the environmental information by the ego vehicle 500 may be hindered by the second vehicle. Note that the vehicle that may hinder acquisition of the environmental information and the vehicle whose environmental sensors 220 are used for acquiring the environmental information may be the same or different. Similarly, when acquisition of the environmental information by the ego vehicle 500 may be hindered by an external object different from the ego vehicle 500, the environmental information obtainer 10 may determine to use the environmental sensors 220 of the second vehicle.

If a NO answer is obtained in step S9, meaning that it is determined not to use the environmental sensors 220 of the second vehicle, then the routine proceeds to step S11 wherein the environmental information obtainer 10 acquires environmental information by using the environmental sensors 220 of the ego vehicle 500. The operation executed in step S11 is the same as that executed in step S10 of FIG. 3. Alternatively, if a YES answer is obtained in step S9, meaning that it is determined to use the environmental sensors 220 of the second vehicle, then the routine proceeds to step S12 wherein the environmental information obtainer 10 acquires environmental information using the environmental sensors 220 of the second vehicle. When the environmental information is acquired from the environmental sensors 220 of the second vehicle, it is preferable that the environmental information obtainer 10 further obtains position information of the second vehicle derived using a GNSS sensor on the second vehicle. This achieves appropriate acquisition of a positional relationship between the environment represented by the environmental information and the ego vehicle. In step S12, the environmental information obtainer 10 may acquire environmental information using the environmental sensors 220 of the ego vehicle 500 in addition to the environmental sensors 220 of the second vehicle.

As described above in connection with the second embodiment, the control device 100 installed in the ego vehicle 500 is capable of deriving the environmental information using the environmental sensors 220 mounted on the second vehicle. This enables the required environmental information to be acquired from the second vehicle when acquisition of the environmental information by the environmental sensors 220 mounted on the ego vehicle is obstructed by an external object such as another vehicle.

### THIRD EMBODIMENT

The control device 100 in the third embodiment includes the space likelihood calculator 30 which is designed to obtain a parking row likelihood representing a higher likelihood when a pattern condition of a crosswalk (which will also be referred to below as a crosswalk pattern condition) on the ground is satisfied than when the crosswalk pattern condition is not satisfied. The crosswalk pattern condition is a condition that a degree of parallelism between the parking space candidates PPS and a crosswalk pattern PPC adjacent to the parking space candidates PPS is equal to or greater than a predetermined reference level. The degree of parallelism herein corresponds to a degree of parallelism between an axis extending in a longitudinal direction of the parking space candidates PPS and an axis extending in the second direction of the crosswalk pattern PPC which is, as already described, orthogonal to the longitudinal direction of the parking space candidates PPS.

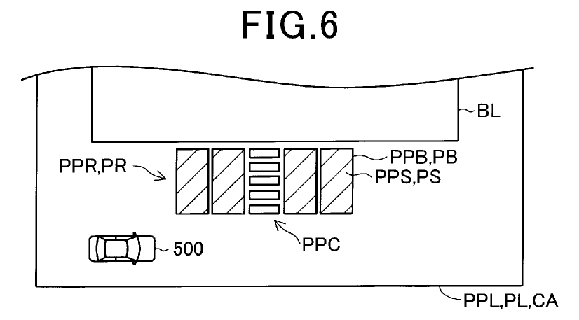

FIG. 6 demonstrates an example of the parking lot PL that satisfies the crosswalk pattern condition. The parking lot PL that satisfies the crosswalk pattern condition is, for example, a parking lot disposed in the vicinity of a building BL such as a convenience store.

As described above in connection with the third embodiment, as compared with a configuration in which the parking row likelihood is simply decreased when the crosswalk pattern PPC is detected, the control device 100 is capable of minimizing, when the crosswalk pattern PPC is detected, a decrease in the parking row likelihood due to, for example, a white line pattern similar to a crosswalk that is often provided in the parking lot PL of a building BL such as a convenience store.

### OTHER EMBODIMENTS

In each of the above embodiments, the control device 100 functions to determine whether the ego vehicle 500 is likely to come into contact with (i.e., enter) the parking lot PL as a function of the parking lot likelihood, the first parking space likelihood, and the second parking space likelihood; however, the present disclosure is not limited thereto. For example, the control device 100 may alternatively determine whether the ego vehicle 500 is likely to come into contact with the parking lot PL in accordance with the parking lot likelihood and the first parking space likelihood, without relying on the second parking space likelihood. In this case, the second parking space likelihood need not be obtained. Alternatively, the control device 100 may function to determine whether the ego vehicle 500 is likely to come into contact with the parking lot PL in accordance with the parking lot likelihood and the second parking space likelihood, without relying on the first parking space likelihood. In this case, the first parking space likelihood need not be obtained.

In each of the above embodiments, the parking lot determiner 45 determines that the ego vehicle 500 is likely to come into contact with (i.e., enter) the parking lot PL when at least one of the first condition, the second condition, and the third condition is satisfied; however, the present disclosure is not limited thereto. For example, the parking lot determiner 45 may determine that the ego vehicle 500 is likely to come into contact with the parking lot PL when the first condition, the second condition, and the third condition are all satisfied. This minimizes an erroneous determination that the parking lot PL is likely to come into contact with the ego vehicle 500 when the ego vehicle 500 is located on a public road or the like, so that the ego vehicle 500 is actually unlikely to come into contact with the parking lot PL. Further, the parking lot determiner 45 may alternatively determine that the ego vehicle 500 is likely to come into contact with (i.e., enter) the parking lot PL when, for example, a total value of the parking lot likelihood, the first parking space likelihood, and the second parking space likelihood is equal to or greater than a predetermined reference value. In this case, the total value may be, for example, a value obtained by summing the parking lot likelihood, the first parking space likelihood, and the second parking space likelihood with predetermined weightings.

In each of the above embodiments, when the parked vehicle candidate PPV is in a stopped state, the parking space likelihood representing a higher likelihood is obtained; however, the present disclosure is not limited thereto.

In each of the above embodiments, when the parking lot candidate PPL corresponds to a predetermined space, the parking lot likelihood representing a higher likelihood is obtained; however, the present disclosure is not limited thereto.

In each of the above embodiments, as the parking lot likelihood, the parking lot likelihood of the parking lot candidate PPL that is in contact with the ego vehicle 500, that is, within which the ego vehicle 500 is present is obtained; however, the present disclosure is not limited thereto. For example, using the predicted trajectory PO, as the parking lot likelihood, the parking lot likelihood of the parking lot candidate PPL for which contact with the ego vehicle 500 is predicted may be obtained.

In each of the above embodiments, the group likelihood is obtained as the first parking space likelihood; however, the present disclosure is not limited thereto. For example, the per-space likelihood or the per-row likelihood may be obtained as the first parking space likelihood. Further, in each of the above embodiments, the per-row likelihood is obtained as the second parking space likelihood; however, the present disclosure is not limited thereto. For example, the per-space likelihood or the group likelihood may be obtained as the second parking space likelihood.

### OTHER MODES

The present disclosure is not limited to the above-described embodiments and may be implemented in various configurations without departing from the spirit thereof. For example, the technical features described in the embodiments may be appropriately replaced or combined in order to solve some or all of the above-described problems or to achieve some or all of the above-described effects. Further, unless described herein as being essential, any of the technical features may be appropriately omitted.

The control device and the method described in the present disclosure may be implemented by a dedicated computer including a processor and a memory programmed to execute one or more functions embodied by a computer program. Alternatively, the control device and the method described in the present disclosure may be implemented by a dedicated computer including a processor configured with one or more dedicated hardware logic circuits. Alternatively, the control device and the method described in the present disclosure may be implemented by one or more dedicated computers including a combination of (i) a processor and a memory programmed to execute one or more functions and (ii) a processor configured with one or more hardware logic circuits. Further, the computer program may be stored, as instructions to be executed by a computer, in a non-transitory tangible computer-readable recording medium.

This disclosure is realized by the following aspects.

### FIRST ASPECT

A control apparatus (100) comprising:
an environmental information obtainer (10) that is configured to obtain environmental information representing an environment around an ego vehicle using one or more sensors including at least a camera (221);
a parking lot likelihood calculator (20) that is configured to use the environmental information to determine a parking lot likelihood (PPL) indicating a likelihood that a parking lot candidate corresponds to a parking lot (PL);
a parking space likelihood calculator (30) that is configured to use the environmental information to determine a parking space likelihood relating to a parking space (PS) in the parking lot; and
a parking lot determiner (45) that is configured to execute a determination process of determining, based on the parking lot likelihood and the parking space likelihood, whether the ego vehicle is likely to come into contact with the parking lot.

### SECOND ASPECT

The control apparatus as set forth in the above-described first aspect, wherein
the parking space likelihood includes a first parking space likelihood regarding a parking space in the parking lot candidate with which the ego vehicle is in contact, and a second parking space likelihood regarding a parking space in the parking lot with which the ego vehicle is predicted to contact, and
the parking lot determiner determines, in the determination process, whether the ego vehicle is likely to come into contact with the parking lot in accordance with the parking lot likelihood, the first parking space likelihood, and the second parking space likelihood.

### THIRD ASPECT

The control apparatus as set forth in the above-described second aspect, wherein
the parking lot determiner is configured to, in the determination process, determine that the ego vehicle is likely to come into contact with the parking lot when at least one of the following conditions is satisfied:
   (i) a first condition that the parking lot likelihood is equal to or greater than a predetermined first threshold,
   (ii) a second condition that the first parking space likelihood is equal to or greater than a predetermined second threshold, and
   (iii) a third condition that the second parking space likelihood is equal to or greater than a predetermined third threshold.

### FOURTH ASPECT

The control apparatus as set forth in any one of the above-described first to third aspects, further comprising:
a moving-vehicle determiner (18) that is configured to determine, based on the environmental information, whether a moving vehicle exists that is moving in a parking frame candidate (PPB) that is a candidate of a parking frame (PB) of the parking space,
   wherein the parking space likelihood calculator is configured to derive, based on a determination result of the moving-vehicle determiner, the parking space likelihood indicating a likelihood that is lower when the moving vehicle exists than when the moving vehicle does not exist.

### FIFTH ASPECT

The control apparatus as set forth in any one of the above-described first to third aspects, further comprising:
a moving-vehicle determiner (18) that is configured to determine, using the environment information, whether a moving vehicle that is moving in the parking frame candidate (PPB) which is a candidate for a parking frame (PB) defining the parking space is present; and
a vehicle controller (60) that is configured to execute parking-lot control, which controls travel of the ego vehicle with respect to the parking lot, when there is a possibility that the ego vehicle contacts the parking lot, wherein
the vehicle controller excludes, when the moving vehicle is present, the parking frame candidate in which the moving vehicle is present from a target location at which the parking-lot control is to be executed.

### SIXTH ASPECT

The control apparatus as set forth in any one of the above-described first to fifth aspects, wherein
the parking space likelihood calculator is configured to:
   determine, using the environment information, whether a parked-vehicle candidate (PPV), which is a candidate for a parked vehicle (PV), is in a predetermined stopped state; and
   when the parked-vehicle candidate is determined to be in the predetermined stopped state, obtain the parking space likelihood representing a higher likelihood than when the parked-vehicle candidate is not in the predetermined stopped state.

### SEVENTH ASPECT

The control apparatus as set forth in any one of the above-described first to sixth aspects, wherein the environmental information obtainer acquires the environment information by using a sensor mounted on another vehicle.

### EIGHTH ASPECT

The control apparatus as set forth in any one of the above-described first to seventh aspects, wherein the environment information includes information representing a pedestrian crossing pattern (PPC) in the parking space candidate, and
wherein the parking space likelihood calculator obtains the parking space likelihood representing a higher likelihood when a degree of parallelism between the parking space candidate, which is a candidate for the parking space, and the pedestrian crossing pattern adjacent to the parking space candidate is equal to or greater than a predetermined reference level than when the degree of parallelism is less than the predetermined reference level.

### NINTH ASPECT

The control apparatus as set forth in any one of the above-described first to eighth aspects, further comprising:
a correspondence determiner (17) that is configured to determine, using the environment information, whether the parking-lot candidate corresponds to a predetermined space, wherein
the parking lot likelihood calculator obtains the parking lot likelihood representing a higher likelihood when the parking-lot candidate corresponds to the predetermined space based on a determination result of the correspondence determiner than when the parking-lot candidate does not correspond to the predetermined space.

What is claimed is:

1. A control apparatus comprising:
an environmental information obtainer that is configured to obtain environmental information representing an environment around an ego vehicle using one or more sensors including at least a camera;
a parking lot likelihood calculator that is configured to use the environmental information to determine a parking lot likelihood indicating a likelihood that a parking lot candidate corresponds to a parking lot;
a parking space likelihood calculator that is configured to use the environmental information to determine a parking space likelihood relating to a parking space in the parking lot; and
a parking lot determiner that is configured to execute a determination process of determining, based on the parking lot likelihood and the parking space likelihood, whether the ego vehicle is likely to come into contact with the parking lot.

2. The control apparatus as set forth in claim 1, wherein
the parking space likelihood includes a first parking space likelihood regarding a parking space in the parking lot candidate with which the ego vehicle is in contact, and a second parking space likelihood regarding a parking space in the parking lot with which the ego vehicle is predicted to contact, and
the parking lot determiner determines, in the determination process, whether the ego vehicle is likely to come into contact with the parking lot in accordance with the parking lot likelihood, the first parking space likelihood, and the second parking space likelihood.

3. The control apparatus as set forth in claim 2, wherein
the parking lot determiner is configured to, in the determination process, determine that the ego vehicle is likely to come into contact with the parking lot when at least one of the following conditions is satisfied:
(i) a first condition that the parking lot likelihood is equal to or greater than a predetermined first threshold,
(ii) a second condition that the first parking space likelihood is equal to or greater than a predetermined second threshold, and
(iii) a third condition that the second parking space likelihood is equal to or greater than a predetermined third threshold.

4. The control apparatus as set forth in claim 1, further comprising:
a moving-vehicle determiner that is configured to determine, based on the environmental information, whether a moving vehicle exists that is moving in a parking frame candidate that is a candidate of a parking frame of the parking space,
wherein the parking space likelihood calculator is configured to derive, based on a determination result of the moving-vehicle determiner, the parking space likelihood indicating a likelihood that is lower when the moving vehicle exists than when the moving vehicle does not exist.

5. The control apparatus as set forth in claim 1, further comprising:
a moving-vehicle determiner that is configured to determine, using the environment information, whether a moving vehicle that is moving in the parking frame candidate which is a candidate for a parking frame defining the parking space is present; and
a vehicle controller that is configured to execute parking-lot control, which controls travel of the ego vehicle with respect to the parking lot, when there is a possibility that the ego vehicle contacts the parking lot, wherein
the vehicle controller excludes, when the moving vehicle is present, the parking frame candidate in which the moving vehicle is present from a target location at which the parking-lot control is to be executed.

6. The control apparatus as set forth in claim 1, wherein
the parking space likelihood calculator is configured to:
determine, using the environment information, whether a parked-vehicle candidate, which is a candidate for a parked vehicle, is in a predetermined stopped state; and
when the parked-vehicle candidate is determined to be in the predetermined stopped state, obtain the parking space likelihood representing a higher likelihood than when the parked-vehicle candidate is not in the predetermined stopped state.

7. The control apparatus as set forth in claim 1, wherein the environmental information obtainer acquires the environment information by using a sensor mounted to another vehicle.

8. The control apparatus as set forth in claim 1, wherein the environment information includes information representing a pedestrian crossing pattern in the parking space candidate, and
wherein the parking space likelihood calculator obtains the parking space likelihood representing a higher likelihood when a degree of parallelism between the parking space candidate, which is a candidate for the parking space, and the pedestrian crossing pattern adjacent to the parking space candidate is equal to or greater than a predetermined reference level than when the degree of parallelism is less than the predetermined reference level.

9. The control apparatus as set forth in claim 1, further comprising:
a correspondence determiner that is configured to determine, using the environment information, whether the parking-lot candidate corresponds to a predetermined space, wherein
the parking lot likelihood calculator obtains the parking lot likelihood representing a higher likelihood when the parking-lot candidate corresponds to the predetermined space based on a determination result of the correspondence determiner than when the parking-lot candidate does not correspond to the predetermined space.
